(19) United States
(12) Patent Application Publication
(10) Pub. No.: US 2010/0307518 A1
(43) Pub. Date: Dec. 9, 2010

(54) SMOKING DEVICE, CHARGING MEANS AND METHOD OF USING IT

(75) Inventor: Xi Yi Wang, Huddinge (SE)

Correspondence Address: SPECKMAN LAW GROUP PLLC, 1201 THIRD AVENUE, SUITE 330, SEATTLE, WA, 98101, US

(73) Assignee: SMOKEFREE INNOTEC CORPORATION, Nashville, TN (US)

(21) Appl. No.: 12/599,794

(22) PCT Filed: May 10, 2008
(86) PCT No.: PCT/IB2008/051871

§ 371 Date: Nov. 11, 2009

(30) Foreign Application Priority Data
May 11, 2007 (EP) 07009545.0

(51) Int. Cl. A24F 47/00; H02J 7/00

(52) U.S. Cl. 131/329; 320/114; 131/270

(57) ABSTRACT

Smoking device (10) comprising a first device (20) and a second device (30). The first device (20) comprises an accumulator for storing electric energy and releasing it to a heating device (22) as a response to a sensor device (24) detecting a suck/draw of the smoking device (10) by a consumer. It further comprises a first air inlet (25) through which an airflow enters said first device (20), passes said heating device (22) and streams out through a first air outlet (26). The second device (30) comprises an agent (33), a second air inlet (35) through which air enters said second device (30), passes through said second device (30), releases said agent (33) by means of dispensing means (37) and streams out through said second air outlet (36) into the mouth of a consumer. Charging means (40) for use with a smoking device (10) and method for using said smoking device (10).

The present application claims the priority of the earlier European Patent Application “Smoking Device, Charging Means and Method of Using It”, Application No. 07 009 545.0, filed on the 11^{th} of May 2007.

The present invention relates to an alternative smoking device, to be used to reduce the negative effects of classic smoking.

With the evolution of technology in the last decades, the tobacco industry has made only a few significant steps towards a reduction of the negative impacts of smoking like low tar and ultra-low tar cigarettes, however the way cigarettes and other tobacco products are manufactured has not had any considerable improvements since the introduction of filter several decades ago. To time there has been no commercially successful alternative smoking product that would considerably reduce the negative effects of the so called second-hand smoking. Some attempts have been made to reduce this side effect but with no considerable results.

With health consciousness rising among population and restrictions related to areas where smoking is not permitted becoming more and more severe, an alternate means of smoking is needed.

Several attempts have been made in the past to provide an alternative smoking solution. Some of these devices fail to provide a viable solution due to their size and complete unresemblance of a regular cigarette, while others fail because of inconvenience of use, low versatility, and high price per unit or in some cases simply bad taste. A common problem of previous devices seems to be the fact that, due to the fact that they use pressure sensors to detect a suck/draw of the device by the consumer, they can not filter out the effects of winds, vibrations or changes in atmospheric pressure. This makes these devices waste significant amount of energy for heating air and agents even when the device is not actually suck/draw on, i.e. while a release of agents is not asked for. A further unsolved problem seems to be their incapacity to precisely release the agents in a predetermined rate and concentration.

The objective of the present invention is thus to provide an alternative means for smoking, which significantly reduces the negative side effects of smoking like second-hand smoking and ash, and greatly reduces the direct negative effects to the smoker itself too, like not being exposed to the very significant amount of toxins which would be the case when smoking a regular cigarette due to burning, but in the same time to provide the consumer a very similar experience to smoking a regular cigarette. These similarities relate to the feel of the alternative means for smoking, i.e. size, look, texture, but also relate to the sensation provided, i.e. a similar taste, temperature and volume of the inhaled air. A further objective of the present invention is to provide a relatively cheap, i.e. comparable over a few month of usage to the price of regular cigarettes, and a versatile, i.e. usable in all environmental conditions, no matter how extreme, alternative smoking device. An even further objective is to provide a smoking device that efficiently uses its energy and agent reserves by releasing these only when this is asked for by the consumer.

The present invention relates to a smokeless smoking device and the related auxiliary devices, which not just reduces, but completely eliminates the smoke resulting from smoking, thus eliminating the effects of second-hand smoking and the unpleasant ash, also greatly reducing the direct negative effects of smoking, while providing to the smoker itself, a very similar smoking experience to the smoking of a classical cigarette. The smoking device according to the present invention achieves these goals by providing a way of consuming the agent, which might be nicotine for example, of the smoking device without actually burning any substance but by bringing the agent into a volatile condition. At the same time, the smoking device of the present invention contains electronic components that enable it to be used in all environmental conditions, being unaffected by atmospheric pressure variations, high winds and temperature changes. Smart electronics ensure an extended life time of the smoking device between consecutive charges. The device of the present invention may use specially designed dispensing means to release the agent in a predetermined rate and concentration.

The advantages of the present invention are immediately apparent based on the objectives of the invention. Eliminating smoke resulting from the act of consuming the smoking device, yield a wider acceptance from the non-smoking population, thus allowing smokers to consume such smoking devices even in areas where smoking in the classical meaning is forbidden. This increases the satisfaction and comfort of smokers, who in certain countries must currently do great efforts sometimes to find a place to smoke, designated smoking areas being in certain cases small, unpleasantly situated and distant. Advantages to non-smokers are also of great interest since in many cases non-smokers have to accept the unpleasant and unhealthy effects of second-hand smoking when they are in company of smokers.

A further advantage of the present invention is the reduction of toxins inhaled by the smoker himself. By replacing the burning of a classical cigarette, together with all the toxins contained, with heated clean air, the smoking device of the present invention reduces the amount of toxins inhaled by the smoker to those that are actually required to achieve the satisfaction of the smoker. These are usually limited to a reduced amount of nicotine combined with flavors and aromas. An other direct positive effect of eliminating burning is that no ash is produced which makes the use of ashtrays obsolete and also contribute to a cleaner smoking act. It is another positive side effect that the risk to cause fires by careless handling is completely eliminated.

Depending on the way the smoking device is used, further advantages may be achieved, for example by gradually reducing the amount of nicotine contained to facilitate quitting smoking, or by using certain medicine agents in the smoking device.

Further characteristics and advantages of the invention will in the following be described in detail by means of the description and by making reference to the drawings. Which show:

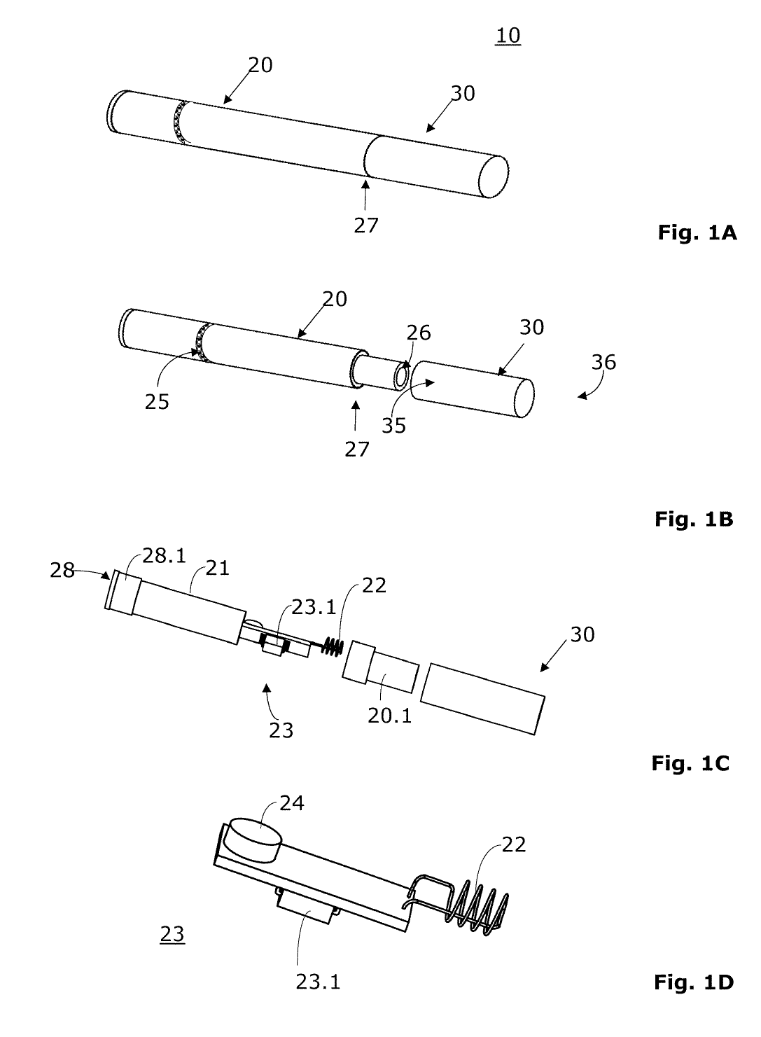

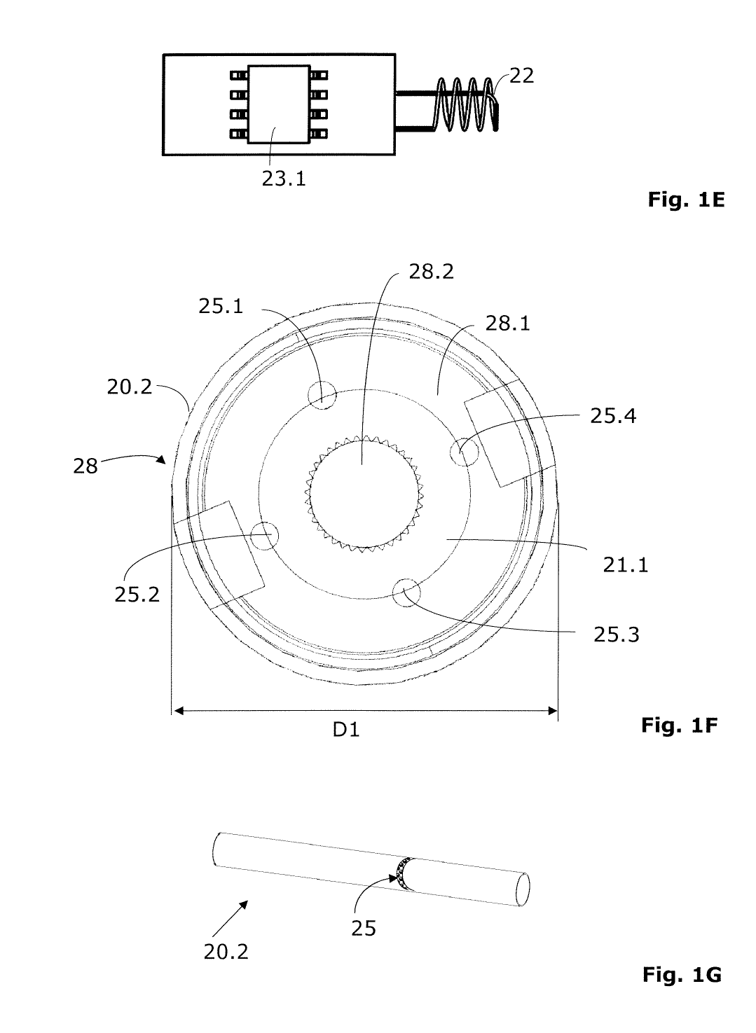

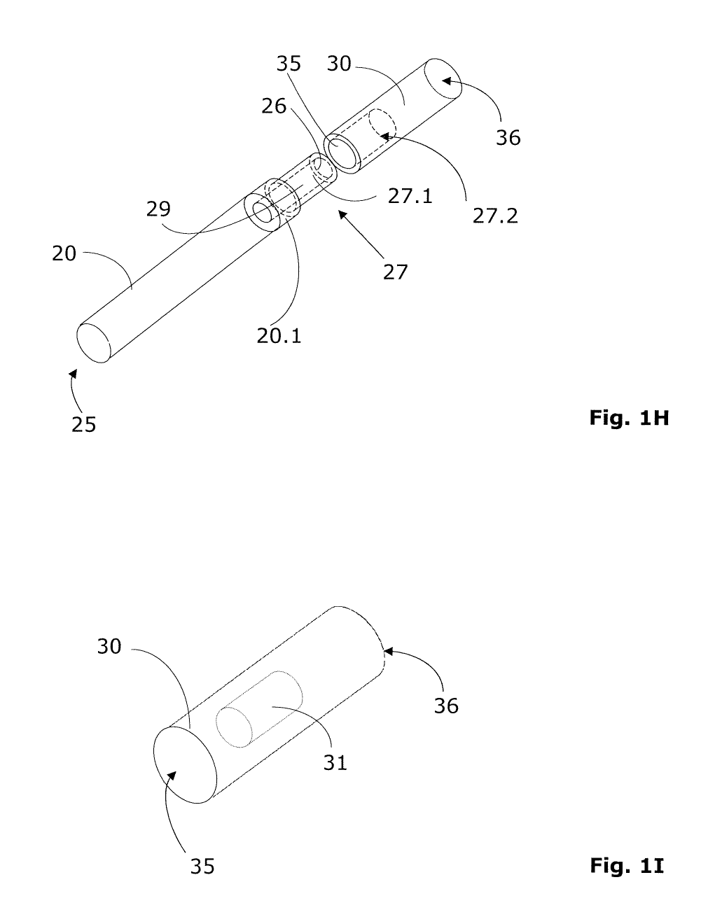

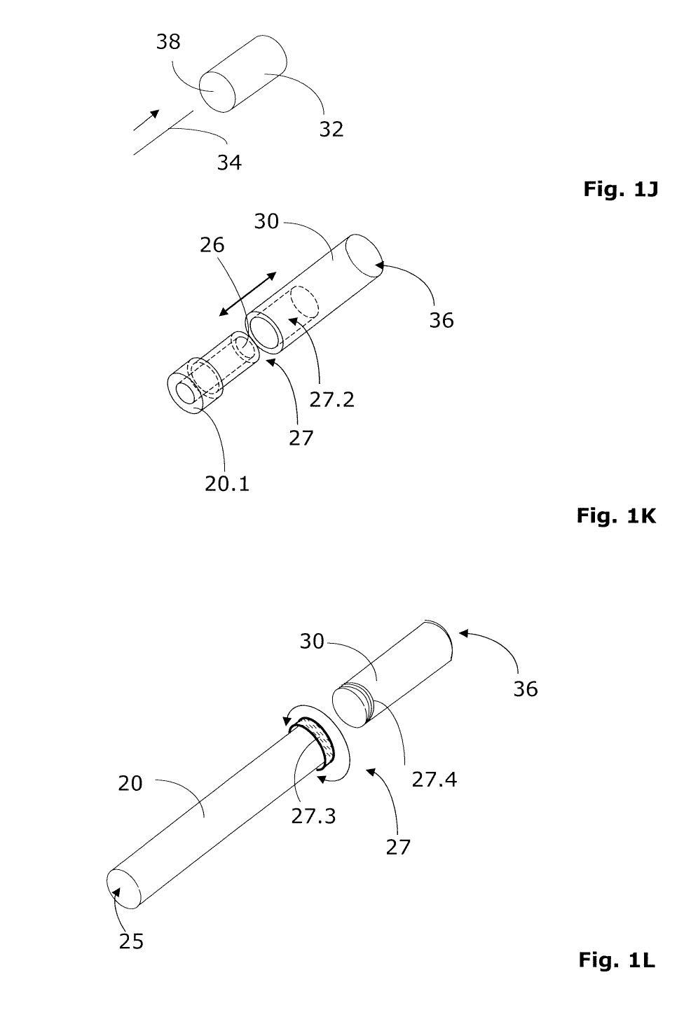

FIG. 1A A perspective view of the smoking device, according to the present invention;

FIG. 1B A perspective view separately showing several parts of the smoking device, according to the present invention;

FIG. 1C A perspective view of the smoking device with the second housing part removed showing several internal parts of the smoking device, according to the present invention;

FIG. 1D A first view of the control electronics and components it comprises, according to the present invention;

FIG. 1E A second view of the control electronics and components it comprises, according to the present invention;

FIG. 1F A frontal view of a first device of the smoking device, according to the present invention;

FIG. 1G A perspective view of a second housing part of the first device, according to the present invention;

FIG. 1H An exploded view showing a first device and a second device, according to the present invention;

FIG. 1I A schematic view of the second device, according to the present invention;

FIG. 1J A schematic view of certain aspects of a second device, according to the present invention;

FIG. 1K A schematic view depicting details of an interface, according to the present invention;

FIG. 1L A schematic view depicting details of a variation of an interface, according to the present invention;

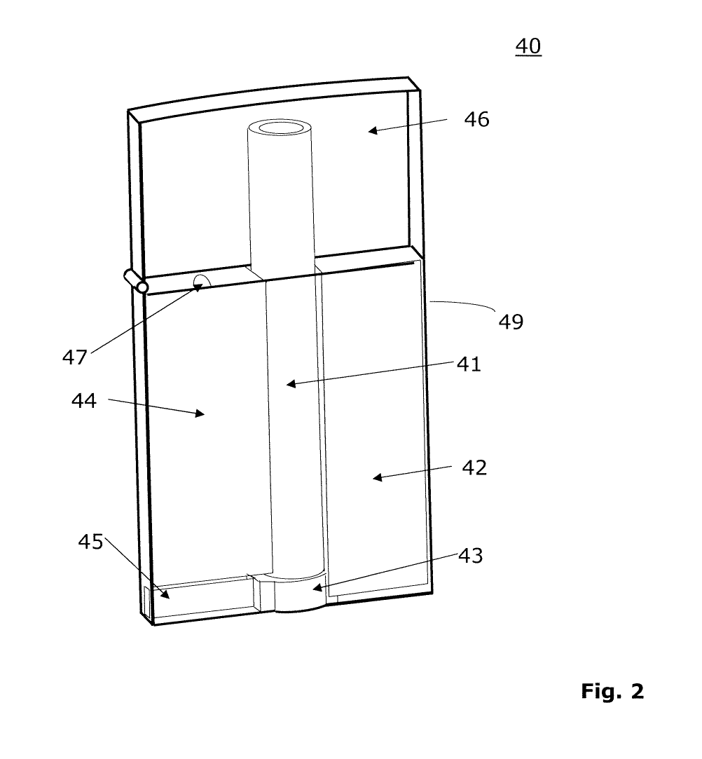

FIG. 2 A see-through perspective view of the charging means according to the present invention;

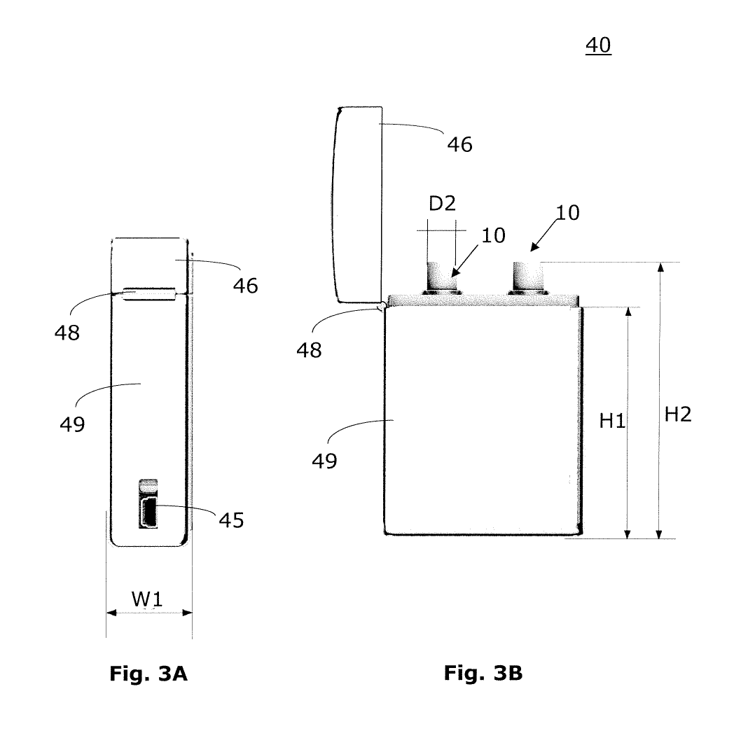

FIG. 3A A side view of the charging means, according to the present invention;

FIG. 3B A front view of the charging means, according to the present invention;

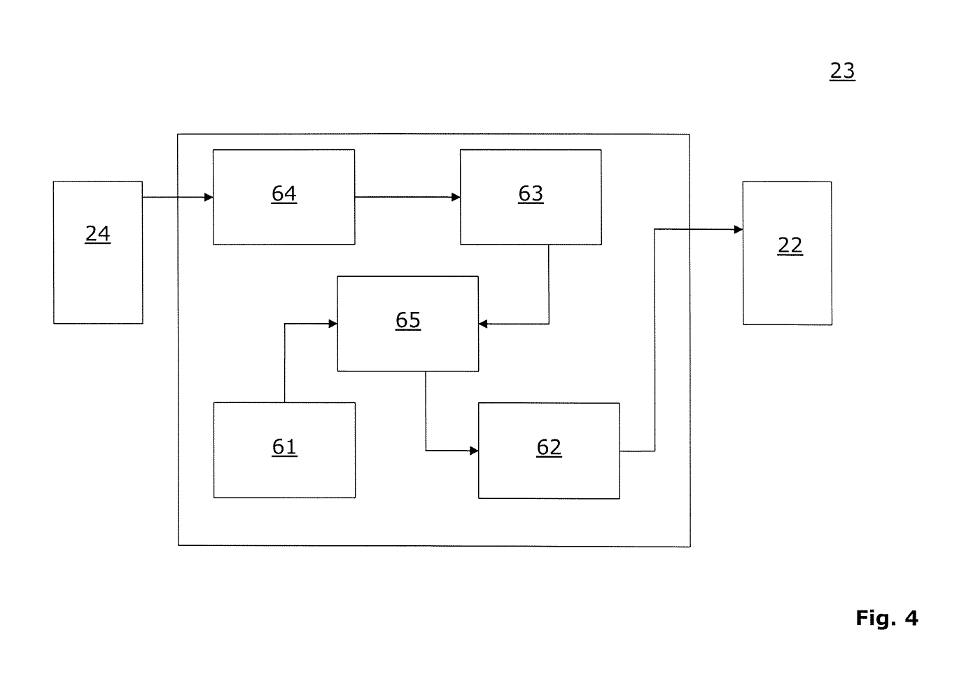

FIG. 4 A schematic block diagram of the control electronics, according to the present invention.

### DETAILED DESCRIPTION

The basic idea of the invention is to have a smoking device 10 which allows inhaling of air filled/enriched with an—not depicted—agent 33, which might comprise nicotine for instance, without having to actually burn any substance. This effect is achieved by the smoking device 10 according to the present invention by employing a heating device 22 which is capable of heating an airflow to such a degree that it is capable to release the agent 33.

The principle of the present invention is being described in relation with a first embodiment as depicted on FIGS. 1A to 1L.

FIG. 1A shows the smoking device 10 with the two main parts, i.e. the first device 20 and the second device 30 connected together as it would be during a regular use of the smoking device 10. These two main parts 20 and 30 of the smoking device 10 are connectable by an interface 27.

FIG. 1B shows the two main parts 20, 30 of the smoking device 10 separated so that further details of these can be seen. The first device 20 comprises a first air inlet 25 for letting fresh air enter the device 20 and a first air outlet 26 for letting air exit the first device 20. The second device 30 comprises a second air inlet 35 meant to receive the airflow that comes out of from the first air outlet 26 and a second air outlet 36 for letting air exit the second device 30. This air that exits the second device 30 is meant to be sucked/drawn in by the consumer of the smoking device 10. The transfer of the air that comes out of from the first air outlet 26 to the second air inlet 35 is achieved by means of the interface 27 which is specially designed so that the first air outlet 26 and the second air inlet 35 are connectable in an airtight manner. In the embodiment depicted in FIG. 1B, the first air inlet 25 is positioned along the second housing part 20.2 of the first device 20 which is provided with recesses or in a further embodiment the second housing part 20.2 is manufactured from a porous material to let air flow through, thus providing for an alternate form for the first air inlet 25, as depicted on FIGS. 1A to 10.

In an even further embodiment, the second housing part 20.2 is perforated so to allow air to pass through, thus said perforations acting as the first air inlet 25. These perforations can vary in diameter from several millimetres to a degree that they are invisible to the naked eye.

A further embodiment of the first air inlet 25 will be described in connection with FIG. 1F.

FIG. 10 shows a perspective view of the smoking device 10 with a second housing part 20.2 (cf. FIG. 1G), which covers the exterior of the first device 20, removed, showing several internal parts of the first device 20 according to a first embodiment of the present invention. These internal parts include in the present embodiment an accumulator 21 for storing and releasing electric energy, a heating device 22 such as a resistive coil, a charging interface 28, and control electronics 23.

In a preferred embodiment the accumulator 21 is a specially designed lightweight and high capacity 200 mAh, 3.7V rechargeable battery which is able to release enough energy to power the control electronics 23 and the energy demanding heating device 22. In a further embodiment of the present invention this accumulator 21 may also be a disposable battery that one can easily replace with a new one or with the previously described rechargeable battery.

In a further embodiment of the present invention the first device 20 comprises an indicating element which is meant to indicate the user of the smoking device 10 the number of draws (puffs) the accumulator 21 is currently able to provide or/and the number of draws the agent 33 in the second device 30 is enough for.

In the depicted embodiment of the present invention the heating device 22 is a resistive coil made of Cr20Ni80, capable of generating enough heat to be able to heat up the airflow that passes through to a temperature level that allows the release of the agent 33 residing in the second device 30. It is also possible to use other restive materials. These temperature levels may vary according to the agent 33 chosen. A typical temperature of the airflow in case of a nicotine agent is between 150° C. and 200° C. In a preferred embodiment of the invention, the temperature is defined (e.g. by programming) taking into consideration the airflow and the temperature drop from the heating coil 22 to the end of the mouth piece. In any case, the temperature at the user's mouth should not exceed the temperature of a regular cigarette to which the consumer is used to. This temperature at the consumer's mouth in a preferred embodiment does not exceed 35° C.-40° C. In the present embodiment, the resistive coil making up the heating device 22 is preheated to a certain level by applying a reduced electrical energy and is fully heated up to 500° C., to 1000° C. or even to 1200° C. (the actual temperature depends on the embodiment of the invention) when an airflow is detected by a sensor device 24, by supplying the full electric energy of the accumulator 21. Usually this heating period is about 5 seconds.

FIGS. 1C and 1D and 1E show several views of the control electronics 23 and the components it comprises, according to the present invention. When the first device 20 is assembled for use, the control electronics 23 that can be seen on these figures is covered by a second housing part 20.2. In the present embodiment of the invention the components making up the control electronics 23 are preferably laid-out on a circuit board.

Besides other electric and electronic components, the circuit board accommodates a processor 23.1. This processor 23.1 is preferably a Field Programmable Grid Array (FPGA) specially set up to achieve all the functions required to operate the smoking device 10. These functions comprise:

Electronically filtering signals received from the sensor device 24, as described in future paragraphs;

Controlling the temperature of the heating device 22 and thus of the airflow passing through an air channel 29, air channel 29 which will be described in connection with FIG. 1H, according to a temperature variation scheme in order to ensure that the airflow is hot enough to dissolve the agent 33, but also to make sure that the air that exists on the second air outlet 36 of the second device 30 is not too hot so as not to burn the lips of the consumer;

Monitoring the energy reserves of the accumulator 21, to ensure proper management of the limited energy this accumulator 21 is able to hold.

The temperature control mentioned above is a very precise and in the preferred embodiment a programmable control scheme. Either at manufacturing or later, the processor 23.1 of the control electronics 23 can be programmed to apply a specially customized temperature variation scheme that optimizes the life of the accumulator 21, the release of the particular agent 33 and thus the operation of the entire smoking device 10. The temperature control also takes into account the ambient temperature since a variation of it has direct influence of the temperature of the air entering the smoking device 10, i.e. the lower the ambient temperature, the more energy must be provided to the heating device 22 to sufficiently heat up the airflow to be able to dissolve the agent 33.

Said temperature control is achieved by means of the processor 23.1 and a temperature sensor. In the preferred embodiment, as temperature sensor a temperature sensor embedded in the processor 23.1 is used. This is done due to the fact that most commercially available processors already incorporate by design a temperature sensor. This way significant amount of space is saved on the circuit board that accommodates the control electronics 23 by eliminating the need to install an additional temperature sensor. However, a further embodiment of the present invention uses a temperature sensor that is not embedded in the processor 23.1, i.e. it is a separate sensor preferably placed on the circuit board.

The above-mentioned programmable temperature variation scheme offers the smoking device 10 a great flexibility as far as the selection of the agent 33 is concerned. This way a wide array of agents 33, each with a different dissolving temperature can be used. Also, by employing a temperature variation scheme, a variation in time of the amount of agent 33 released to the consumer can be also achieved, variation that resembles the variation of tobacco, nicotine and other aroma release of a regular cigarette due to the fact that, in the case of regular cigarettes, the flame gradually approaches the consumer.

In the preferred embodiment of the present invention, the sensor device 24 is a specially adapted microphone. Most preferred are electret microphones, which eliminate the need for a power supply by using a permanently charged material. Eliminating the need for a power supply is especially advantageous due to the extreme size, weight and thus energy reserve restrictions of the smoking device 10. The most important part of these microphones is the electret, a stable dielectric material with a permanent static electric charge. The main advantage of using an electret microphone is its low cost, reduced size and almost zero energy requirement.

This sensor device 24 has the main purpose to detect airflow through the first device 20 emitting a signal to the control electronics 23 which in turn will cause the accumulator 22 to release its entire electric energy to the heating device 22 in order to reach the temperature level discussed in a previous paragraph.

In the following, we will call “suck/draw detection”, the precise detection of the moment of suction of/or drawing at the smoking device 10 by the consumer. This suck/draw refers only to an intentional suck by the consumer of the smoking device 10 as it is intended to be used, i.e. a suck/draw that is similar to the suck/draw of a regular cigarette. The suck/draw detection does not refer to detecting other airflow in the smoking device due to winds, sudden pressure changes, etc, which we call in the following noise, or false detection.

Precise suck/draw detection is essential to minimize the time the heating device 22 is powered and thus significantly reduce its energy consumption. A major concern during the suck/draw detection is the need to filter out noises, i.e. false signals of detection that would lead to wasted energy.

According to the present invention there are three main approaches to this filtering:

In the preferred embodiment, the electret microphone is specially constructed in order to have a narrow frequency response that corresponds to the frequency of the vibration created by a cigarette consumer's suck/draw. Usually this frequency range is situated below 5 Hz, a range low enough to eliminate the possibility of a false detection, since most environmental noises are above this frequency. This solution we hereby call mechanical filtering, since the mechanical properties of a vibrating element of the sensor device 24 are being adjusted to narrow the frequency response. This can be done by manufacturing the vibrating element of the microphone from a more firm material or provide additional damping that eliminates higher frequency vibrations.

A further approach is the use of a passive electrical filter that filters out a selected frequency range, such as a common bandpass filter. The frequency range, around 5 Hz, is in this case adjusted by the proper selection of the electrical components of the passive electrical filter. In the most basic embodiment, this passive electrical filter is what is commonly known as an RLC circuit.

In a further embodiment of the present invention, where the control electronics 23 comprise a complex and powerful enough processor 23.1, an active, electronic signal filtering is implemented in said processor 23.1. In this case an unfiltered signal representing all vibrations around the sensor device 24 are transmitted to the processor 23.1, where this signal will be electronically filtered in order to detect the suck/draw and only the suck/draw on the smoking device 10, while all noise is to be ignored. Since an active electronic filtering can be programmed to be more complex than a passive mechanical or electric filter, the accuracy of the filtering and thus of the suck/draw detection can be increased. The basic filtering of these active electronic filters implemented in the processor 23.1 is also a bandpass filter around 5 Hz, but additional advanced filtering is performed to eliminate noise and increase the accuracy of the suck/draw detection.

In view of the suck/draw detection one should note a further reason for employing a microphone as a sensor device 24. It is the fact that the alternative solution, the use of a pressure sensor, has significant drawbacks. The most important reason why the employment of a pressure sensor is not favored is that a wind or an altitude difference can offset this sensor, thus picking up noise, thus giving false signals to the processor 23.1, false signals that do not actually relate to a suck/draw on the smoking device 10 by the consumer, but are due to environmental factors. The constant adaptation of the smoking device 10 and especially of the control electronics 23 to these unpredictable environmental factors, in order to be able to use a pressure sensor as the sensor device 24 used for suck/draw detection, would require complicated electrics and constant energy pickup that would drain the accumulator 21.

FIG. 1F shows a top view of the first device 20. This view provides further details of the charging interface 28, which comprises a first contact 28.1 a second contact 28.2, which are electrically isolated from each other by a battery cover 21.1. The first contact 28.1 and the second contact 28.2 are provided to allow for a charging of the accumulator 21 by charging means 40 which will be described in a later section of the description. In the depicted embodiment these contacts 28.1, 28.2 are arranged as two concentric circles, but in different embodiments these contacts may be arranged differently, as two adjacent electrically isolated half circles for example. In further embodiments the charging interface 28 is a standardized interface connectable to a standard charging device 40, such as the charger of a mobile phone or a mini USB port for example.

In the further embodiment depicted on FIG. 1F, the battery cover 21.1 is provided with recesses 25.1-25.4 which act as the first air inlet 25. In different embodiments this first air inlet 25 can be positioned along the second housing part 20.2 of the first device 20 which in these cases might be provided with recesses or in an even further embodiment the second housing part 20.2 is manufactured from a porous material to let air flow through, thus providing for an alternate form for the first air inlet 25, as depicted on FIGS. 1A to 10.

In an even further embodiment, the second housing part 20.2 is perforated so to allow air to pass through, thus said perforations acting as the first air inlet 25. These perforations can vary in diameter from several millimetres to a degree that they are invisible to the naked eye.

FIG. 1G shows a second housing part 20.2 which is designed to cover most or all of the length of the second device 20. Special care has been taken to ensure that said second housing part 20.2 resembles as much as possible the paper tube (usually white) which holds the tobacco portion of a regular cigarette. This resemblance relates to length, diameter D1, texture and color to give a few examples.

FIG. 1H shows a first housing part 20.1 and the second device 30. The first housing part 20.1 is situated at the same end of the first device 20 as the heating device 22 (not shown on FIG. 1H). This first housing part 20.1 is preferably made of a heat resistant and isolating material like ceramics for instance, in order to withstand and isolate the heat emitted by the heating device 22. In a preferred embodiment the first housing part 20.1 is designed to be able to accommodate the interface 27 to make possible an airtight connection between the first device 20 and the second device 30. Due to its placement at the tip of the first device 20, the first housing part 20.1 preferably comprises the first air outlet 26. This is preferred because the air flowing out of the first air outlet 26 is the air heated up by the heating device 22, which makes mandatory the use of a heat resistant and isolating material, of which the first housing part 20.1 is preferably made of. This figure also shows an air channel 29 designed so as to guide the airflow through and/or around and/or along the heating device 22.

In a further embodiment of the present invention, the first housing part 20.1 is a separate independent part that comprises the interface 27 and may also accommodate the container 32 with the agent 33.

The second device 30 is also shown on FIG. 1H in relation with the first housing part 20.1 illustrating the way the interface 27 connects the first air outlet 26 and the second air inlet 35. The second air outlet 36 of the second device 30 is where the heated air containing a dose of the dissolved agent 33 is intended to exit the smoking device 10. In an intended use of the preferred embodiment of the present invention, at least a part of the second device 30 is held in the consumer's mouth with at least the second air outlet 36 being in the consumer's mouth, to facilitate inhaling of the air coming out of said second air outlet 36. While designing the second device 30, special care has been taken to insure that said second device 30 resembles as much as possible the end part (usually the filter) of a regular cigarette. This resemblance relates to length, diameter D2, texture, taste and color to give a few examples. It is to be noted that, even if this second device 30 resembles the filter part of a classical cigarette, it is not necessarily a filtering device since the air flowing through contains only pure dissolved agent 33 and no other “secondary compounds” like tar, found in the airflow of a regular cigarette, making a filtering of the airflow in the smoking device 10 obsolete. The agent 33 in the second device 30 contains only the desired components and no additional chemicals are dissolved, thus filtering of the air is not needed. In a preferred embodiment the filtering device acts as a retention means having well a defined retention characteristic.

Further constraints while designing the second device 30, were low cost and disposability, the second being of great ecological interest since the second device 30 is not necessarily reusable, i.e. it will most probably be produced in large quantities.

Both first air inlet 25, second air inlet 35 and both first air outlet 26, second air outlet 36 together with the air channel 29 are designed so that a standard volume per suck/draw is allowed to path through to the consumer in order to bring the experience of using the smoking device 10 even closer to the experience of smoking a regular cigarette.

FIGS. 1K and 1M depict several variations of the interface 27 that connects the first housing part 20.1 of the first device 20 with the second device 30 in an airtight manner.

On FIG. 1K the interface 27 that connects the first device 20 with the second device 30 may be a pair of interconnecting tubular sections that fit into each other. The second device 30 has a tubular extension 27.1 with a diameter smaller than the outer diameter D1 of the entire second device 30. This tubular extension 27.1 fits in a corresponding tubular cut 27.2 in the first device 20. When pushed together, the tubular extension 27.1 as inserted in the tubular cut 27.2 forms the airtight interface 27. In a further embodiment of the present invention, the tubular extension 27.1 is part of the second device 30 and the tubular cut is part of the first device 20. In this further embodiment, the first housing part 20.1 may also be a part of the second device 30.

In an even further embodiment, the interface 27 is a separate, independent part that is connected between the first air outlet 26 of the first device 20 and the second air inlet 35 of the second device 30. In this embodiment, the interface 27 also comprises the first housing part 20.1 and the container 32 with the agent 33.

FIG. 1L shows a further embodiment of the interface 27 where both the first air outlet 26 and the second air inlet 35 have flat outer surface and they are joined together by simply pressing the two together. In order to achieve an airtight interface 27, an additional seal ring 27.3 is provided on the first device 20 which can be either twisted on a corresponding thread 27.4 on the second device 30, or it can be pulled on longitudinally on the end of the second device 30.

Various sealant materials can also be used in connection with any of the previously mentioned variants of the interface 27 if needed. These can be in the form of coatings of various surfaces making up the interface 27 just to give an example.

Not visible on the figures is the agent 33 that the second device 30 contains. This agent 33 can comprise various substances. In a first embodiment the agent 33 comprises nicotine among flavors and aromas (possibly with tobacco taste). According to the present invention the second device 30 is manufactured with different compositions of agents 33. This yields a lot of very useful applications of the invention. For instance the disposable second devices 30 may be packaged in large lots with each piece containing a slightly smaller amount of nicotine with the aim of helping one get rid of a nicotine addiction. In a further embodiment several flavors or aromas may be added to the agent 33 to resemble different brands and types of cigarettes. In a still further embodiment the agent 33 comprises certain medicines that are dissolvable by a flow of heated air. To give an example these medicines might be ones to cure asthma. In this further embodiment the agent 33 does not contain tobacco flavour, but medicines which have been proved to be better received by the human body when administered orally in the form of warm or hot vapours.

Providing the second device 30 with said agent 33 and the release of said agent 33 has several possible means:

In a first embodiment the agent 33 is sealed in a container 32 and placed in a corresponding container section 31 of the second device 30 as shown in FIG. 11. The container 32 has a thin cover layer 38 which is then perforated by an optional means for piercing 34 of the first device 20 as shown on FIG. 1J. Said means for piercing 34 may be attached to the first device 20 so that when connecting the second device 30 via the interface 27, the thin cover layer 38 is perforated so as to facilitate an exposure of the agent 33 to the airflow flowing through the second device 30.

In a further embodiment the second device 30 comprises an impregnable material which can be impregnated by the agent 33 in such a way that said agent 33 is dissolvable from said material by the airflow flowing through the second device 30. In this embodiment the optional means for piercing 34 is not needed anymore but the second device 30 is packaged at manufacturing in a sealed packaging to prevent exposure of the agent 33 to unwanted airflow. Said sealed packaging must be removed before one intends to use the second device 30.

In an even further embodiment, the agent 33 is confined within a very thin container 32, container 32 made of a material which is dissolvable by the heated air flowing through the second device 30. Special care has been taken when selecting the material of the container 32 in this case the two main requirements being a low melting temperature and at the same time the release of no toxic vapours while melting. In a further embodiment of the present invention, the temperature variation scheme described before is programmed so that, when connecting the second device 30 and the first device 20, a short high energy pulse is provided to the heating device 22, which in reaction emits a strong heat pulse, which in turn is able to melt the thin container 32. This quick heat pulse is provided immediately after connecting the first device 20 with the second device 30 and the melting of the container 32 happens before the consumer puts the smoking device into his/her mouth, thus avoiding burns that otherwise could occur due to the heat pulse or exposure to toxic compounds due to the melting of the container.

A further embodiment of the smoking device 10, the agent 33 is confined in a container 32 within the interface 27 which is in this embodiment is a separate, independent part that is connected between the first air outlet 26 of the first device 20 and the second air inlet 35 of the second device 30.

The above mentioned means for providing the second device 30 with said agent 33 and the release of said agent 33 are herein called dispensing means 37.

FIG. 2 shows charging means 40 intended to be used with the smoking device 10. In the depicted preferred embodiment, the charging means 40 also acts as a storage device for the smoking device 10. For this reason the charging means 40 depicted is situated in a housing 49.

The essential components of the charging means 40, as depicted on this figure, comprise a bay 41 for receiving at least part of said smoking device 10, an accumulator 42 and charger contacts 43 which are arranged in or at said bay 41 so as to be able to establish electric contacts between the accumulator 42 and corresponding contacts 28.1, 28.2 of the charging interface 28 of the smoking device 10.

The bay 41 is designed so as to be able to accommodate at least the end of the smoking device 10 with the charging interface 28. In the preferred embodiment depicted on FIG. 2, the bay 41 is able to accommodate the entire first part 20 of the smoking device 10. This feature allows the charging device 40 to be used as a storing device as well with the aim of protecting and storing the smoking device 10 while being charged or simply not in use. In a further embodiment the bay 41 is interchangeable so that the same charging means 40 may be used with several types and sizes of the smoking device 10 by attaching the appropriate bay 41 having also the appropriate charger contacts 43.

The high capacity accumulator 42, which should not be confused with the accumulator 21 of the smoking device 10, has the role of storing electrical energy that is sufficient to charge several times the lower capacity accumulator 21 while the smoking device 10 resides in the bay 41. In a preferred embodiment this accumulator 42 is a 7.4V, 400 mAh battery. This layout allows the consumer of the smoking device 10 to use it several times without the need to be near an electrical outlet or other source of electricity to charge the accumulator 21 of the smoking device 10. This feature of the charging means 40 gives a higher degree of autonomy to the smoking device 10, giving the consumer a similar experience to having a pack of regular cigarettes at his disposal. Similarly as with a pack of regular cigarettes, the consumer would open the cover 46 of the charging means 40, take out the smoking device 10 and have a smoke comprising about the same number of draws as a regular cigarette would allow. After the smoke, the consumer would put back the smoking device 10 in the charging means 40 so that the smoking device 10 can be charged for a new smoke when needed, and dispose the empty/agent-free second device 30 or refill the second device 30 with an agent 33.

In the context of the present invention the act of a smoke relates to the usual meaning of having a smoke comprising multiple draws, meaning sucking/drawing the tip of a cigarette, thus causing a certain amount of chemicals like nicotine and flavours to be carried by the hot airflow and to enter ones mouth.

In a preferred embodiment the charging means 40 also comprises an electronic circuit 44. This has the main role to control the charging of the smoking device 10. The charging means 40 is preferably capable of charging the accumulator 21 of the smoking device 10 several times. A secondary role of the charging means 40 is to provide the smoking device 20 a minimum power in order to keep it functional during an extended period of time, while the smoking device 10 resides in it of course. The said extended period of time can be in the preferred embodiment up to 6 month.

The electronic circuit 44 may also be capable of keeping a record of the amount of charges and generally usage data related to the smoking device 10. In order to take advantage of said usage data, the charging means 40 also comprises an interface 45 providing for a contact between said electronic circuit 44 and an external computing device. This interface 45 is preferably a standard interface used in computing applications, in the preferred embodiment being a USB (Universal Serial Bus) interface. The data recorded gives the possibility to analyze ones smoking habits or in case an agent 33 with medicine compounds is used, to analyze results and dosages. In a further embodiment the computing device which is connected to the interface 45 is capable of transmitting the recorded data to a central database. In this case a more general statistical analysis can be drawn up using the data transmitted to said central database. These analyses can serve health, commercial or sociological purposes for example.

The interface 45 may also serves the role to enable a charging of the accumulator 42 of the charging means 40. This charging can be done by connecting the interface 45 to a computing device and transferring electrical energy from it, or by connecting an AC or DC charger having a corresponding interface. Several such chargers are available on the market such as 110/220V AC power outlet chargers or 12V DC car chargers just to give a few examples.

FIGS. 3A and 3B show further views of an embodiment of the charging means 40.

FIG. 3A shows a side view on which the standard USB interface 45 and a hinge 48 to hold the cover 46 are visible. W1 as seen on this figure is the preferred width of the charging means 40 which is chosen so that the charging means 40 can accommodate the appropriate bay 41 and the other components of the charging means 40.

FIG. 3B shows a front view of a further embodiment of the charging means 40 according to the present invention. This embodiment is able to accommodate two smoking devices 10, having accordingly two sets of bays 41 and charger contacts 43. This specific layout might have several purposes like to be able to share the same charger means 40 between a smoking couple or in case the charging time, needed for the charging means 40 to charge the accumulator 21 of the smoking device 10 for a new smoke, is considered to long for “heavy smokers”. Following the same concept charging means 40 being able to accommodate a different number of smoking devices 10 are also possible. Also shown on this figure are H1 which is so chosen to be able to accommodate a smoking device of height H2. Diameter D2 of the smoking device 10 is also shown here which directly determines the inner diameter of the bay 41.

In a further embodiment, the charger means is a car charger which might be incorporated in a car's dashboard and/or replacing the classical cigarette lighters currently included on almost all current cars. For users of cars that have the currently fitted classical cigarette lighters, an adaptor may be provided which on one side fits the standard plug these classical cigarette lighters use, and on the other side is able to connect to the charging interface 28 of the smoking device 10.

FIG. 4 shows the main structural blocks of the control electronics 23, according to the present invention. This includes an electret-type sensor device 24, an 8-bit Central Processing Unit 65, a heating device 22, a temperature control unit 61, a Pulse Width Modem 62, a 12 bit Analog/Digital converter 63 and a Programmable Gate Array 64.

The system depicted on this figure functions as follows:

when the smoking device 10 is not sucked on/drawn, then the system will be in an idle or standby state with a power consumption of less then 10 μA;

as soon as the smoking device 10 is sucked on/drawn, the sensor device 24 will pick up an analog signal which will then be converted into a digital signal by the 12 bit Analog/Digital converter 63. The digital signal will then be analyzed by the CPU with aid of the Pulse Width Modem 62 and, if the signal matches a pattern that corresponds to an actual suck/draw and not noise, the temperature control unit 61 will engage the heating device 22 in such a way as to achieve the preprogrammed temperature variation scheme detailed in a previous paragraph.

It will be understood that many variations could be adopted based on the specific structure hereinbefore described without departing from the scope of the invention as defined in the following claims.

1-21. (canceled)

22. A smoking device having an elongated shape similar to a regular cigarette and comprising a first device having a housing part covering the exterior of the first device and a second device,
wherein said first device comprises:
an accumulator for storing and releasing electric energy,
a heating device to which electric energy from said accumulator is applied,
a first air inlet positioned along the housing part and a first air outlet arranged at the end of the housing part so that an airflow entering said first device at said first air inlet passes through an air channel around said heating device and streams out through said first air outlet,
control electronics for controlling the temperature of the heating device and for monitoring the energy reserves of the accumulator, and
a sensor device for detecting an airflow created by sucking/drawing at the smoking device and emitting a signal to the control electronics for releasing the full electric energy of the accumulator during a short heating period,
and wherein said second device comprises:
an agent,
a second air inlet and a second air outlet arranged so that the airflow entering said second device through said second air inlet passes through said second device and streams out through said second air outlet, and
dispensing means for controlling the releasing of said agent to the airflow, further comprising an interface for connecting said first device and said second device so that said first air outlet is connected in an airtight manner to said second air inlet.

23. The smoking device of claim 22, wherein said housing part comprises a first housing part situated at the end of the first device and a second housing part covering the accumulator, the sensor device, the control electronics and the heating device.

24. The smoking device of claim 23, wherein said first housing part is made of heat resistant and isolating material.

25. The smoking device of claim 22, wherein said interface is provided by a tubular extension and a corresponding tubular cut.

26. The smoking device of claim 22, wherein said sensor device is a microphone and said control electronics comprise active and/or passive filters to filter signals received from the sensor device.

27. The smoking device of claim 26, wherein said control electronics comprise a processor programmed to electronically filter signals received from the sensor device.

28. The smoking device of claim 22, wherein said accumulator comprises a charging interface by means of which it is connectable to charging means.

29. The smoking device of claim 22, wherein said heating device comprises a resistive coil of material which stands temperatures of at least 500° C., in order to heat the airflow up to 200° C. during the short heating period.

30. The smoking device of claim 22, further comprising an indicating element that provides a consumer of said smoking device with status information.

31. The smoking device of claim 22, wherein said control electronics further comprises:
a temperature control unit;
a pulse width modern;
an analog/digital converter;
a programmable gate array; and
a central processing unit.

32. The smoking device of claim 22, wherein said second device is designed for one-time use and has the shape of the filter portion of a regular cigarette.

33. The smoking device of claim 22, wherein said first device is reusable and has the shape of the tobacco portion of a regular cigarette.

34. A charging means for use with a smoking device of claim 23, said charging means comprising a bay for receiving at least part of said smoking device, an accumulator and charger contacts which are arranged in or at said bay so as to establish an electric contact between said accumulator and corresponding contacts of said smoking device.

35. The charging means of claim 34, wherein said bay has a cylindrical, hollow shape so that said smoking device can be slide in until the electric contact is established.

36. The charging means of claim 34, further comprising an electronic circuit for controlling the charging of said smoking device by said accumulator.

37. The charging means of claim 36, further comprising an interface providing for a contact between said electronic circuit and an external computing device.

38. The charging means of claim 34, wherein the charging means is a portable charging case that serves as storage and charging means for charging a smoking device prior to use.

39. The charging means of claim 34, wherein the charging means is installed into a vehicle to enable the charging of a smoking device prior to use.

40. A method of using a smoking device of claim 22, comprising the following steps:
charging the accumulator of said first device,
connecting the first device and second device,
putting an end portion of said second device between one's lips,
sucking/drawing air through said second device as if one would be using a regular cigarette,
said processor, as part of the control electronics, detecting the sucking/drawing of air, by means of said sensor device,
in response to the detection of the sucking/drawing of air, releasing electric energy from said accumulator for heating said heating device and for heating an airflow streaming through said smoking device, and
releasing part of said agent, by means of said dispensing means, while the airflow, after having been heated by said heating device, passes said second device.

41. The method of claim 40, further comprising the step of:
connecting said first device with separate charging means, so as to establish an electric contact between said charging means and corresponding contacts of said smoking device prior to charging the accumulator of said first device.

42. Method of claim 41, further comprising the steps of:
storing said first device in a portable case,
while being stored in said portable case, providing an electric contact between an accumulator contained in said portable case and corresponding contacts of said smoking device in order to charge the accumulator of said first device.
